(19) United States
(12) Patent Application Publication
(10) Pub. No.: US 2025/0251310 A1
(43) Pub. Date: Aug. 7, 2025

(54) BEARING TESTING DEVICE AND TESTING METHOD USING THE SAME

(71) Applicant: Aktiebolaget SKF, Göteborg (SE)

(72) Inventors: Ruixiang ZHU, Suzhou (CN); Xiaofeng YAN, Shanghai (CN); Zhongfa YIN, Shanghai (CN); Gaojie JIANG, Shanghai (CN); Huailong LI, Huji (CN); Wujian FENG, Shanghai (CN); Shaozhi LI, Shanghai (CN)

(21) Appl. No.: 19/032,582

(22) Filed: Jan. 21, 2025

(30) Foreign Application Priority Data
Feb. 2, 2024 (CN) 202410150034.2

(51) Int. Cl. G01M 13/04

(52) U.S. Cl. CPC G01M 13/04

(57) ABSTRACT

A bearing testing device and a method for testing bearing performance in a bearing misaligned state by the bearing testing device is disclosed. The bearing testing device tests the performance of a first bearing and/or a second bearing in a misaligned state. The testing device includes a main shaft for installing the first and second bearings to be tested. A first adjusting plate rotates around a first axis perpendicular to the main shaft for a certain angle, and directly or indirectly holds the outer ring of the first bearing. A second adjusting plate rotates around a second axis perpendicular to the main shaft for a certain angle, and directly or indirectly holds the outer ring of the second bearing. An actuating assembly adjusts the angle of the first adjusting plate relative to the first axis and the angle of the second adjusting plate relative to the second axis.

### CROSS-REFERENCE TO RELATED APPLICATION

This application claims priority to Chinese Application No. 202410150034.2, filed Feb. 2, 2024, the entirety of which is hereby incorporated by reference.

### FIELD

The present disclosure relates to the technical field of bearing testing. In particular, it relates to a bearing testing device suitable for testing the performance of a first bearing to be tested and/or a second bearing to be tested in a misaligned state, and to a testing method using the bearing testing device.

### BACKGROUND

Bearings are important components widely used in all kinds of machinery, and play an important role in supporting the rotating body of machinery, reducing the friction coefficient during the movement and ensuring the rotary accuracy. The performance of bearings directly affects the performance of the machinery. Therefore, it is very important to test the performance of the bearings.

Since the bearing may be in a misaligned state during actual operation, it is necessary to simulate the operation of the bearing in a misaligned state and conduct corresponding bearing performance tests.

However, in the current misaligned performance test, the misalignment of the bearing can not be accurately controlled and measured, especially in the process of test operation, the position adjustment and stress of the bearing can not achieve a “closed-loop control”, which makes the performance of the bearing under a misaligned state can not be effectively verified.

### SUMMARY

In view of the problems and demands mentioned above, the present disclosure proposes a bearing testing device and a testing method using the bearing testing device, which solves the above problems and brings other technical effects by adopting the following technical features.

On the one hand, the present disclosure provides a bearing testing device, which is used to test the performance of a first bearing to be tested and/or a second bearing to be tested in a misaligned state, and comprises a main shaft configured to install the first bearing to be tested and the second bearing to be tested; a first adjusting plate configured to be able to rotate around a first axis perpendicular to the main shaft for a certain angle, and configured to directly or indirectly hold the outer ring of the first bearing to be tested; a second adjusting plate configured to be able to rotate around a second axis perpendicular to the main shaft for a certain angle, and configured to directly or indirectly hold the outer ring of the second bearing to be tested; an actuating assembly configured to adjust the angle of the first adjusting plate relative to the first axis and the angle of the second adjusting plate relative to the second axis.

According to a preferred solution, the bearing testing device further comprises a plurality of distance sensors for measuring distances between the first adjusting plate and the second adjusting plate at a plurality of different positions.

According to a preferred solution, the plurality of distance sensors comprise a first distance sensor, a second distance sensor and a third distance sensor which are uniformly arranged around the axis of the main shaft.

According to a preferred solution, the actuating assembly comprises a first oil cylinder, a second oil cylinder and a third oil cylinder for applying forces along an axial direction of the main shaft to the first adjusting plate; wherein, the first oil cylinder, the second oil cylinder and the third oil cylinder are installed on the first adjusting plate, and their respective push rods abut against the second adjusting plate; wherein the first oil cylinder and the first distance sensor are arranged at a same circumferential angle, the second oil cylinder and the second distance sensor are arranged at a same circumferential angle, and the third oil cylinder and the third distance sensor are arranged at a same circumferential angle.

According to a preferred solution, the second cylinder and the third cylinder are arranged at a same height.

According to a preferred solution, the bearing testing device further comprises a first supporting structure, and the first adjusting plate is supported by the first supporting structure and can rotate around a first axis relative to the first supporting structure; the bearing testing device further comprises a second supporting structure, and the second adjusting plate is supported by the second supporting structure and can rotate around a second axis relative to the second supporting structure; wherein the first supporting structure and the second supporting structure are configured to be able to apply forces in a radial direction to the first adjusting plate and the second adjusting plate, respectively.

According to a preferred solution, the bearing testing device further comprises a first support bearing and a second support bearing installed to the main shaft, and the first support bearing and the second support bearing are located at both sides of the installation positions of the first bearing to be tested and the second bearing to be tested.

According to a preferred solution, the bearing testing device also comprises three springs located between the first adjusting plate and the second adjusting plate, and each spring is consistent with the position of the corresponding oil cylinder.

The present disclosure also relates to a method for testing the performance of a first bearing to be tested and a second bearing to be tested in a misaligned state by the bearing testing device according to any one of the above mentioned embodiments comprising: installing a first bearing to be tested and a second bearing to be tested on a main shaft of the bearing testing device, and fixing an outer ring of the first bearing to be tested and an outer ring of the second bearing to a first adjusting plate and a second adjusting plate respectively; adjusting the angle of the first adjusting plate relative to a first axis and the angle of the second adjusting plate relative to a second axis by means of the actuating assembly until a predetermined misaligned state of the first bearing to be tested and the second bearing to be tested is reached.

According to a preferred solution, the bearing testing device further comprises a plurality of distance sensors for measuring distances between the first adjusting plate and the second adjusting plate at a plurality of different positions, wherein angles of the first adjusting plate relative to the first axis and the second adjusting plate relative to the second axis are adjusted based on readings of the plurality of distance sensors.

Below, the preferred embodiments for implementing the present disclosure are described in greater detail, referring to the accompanying figures, to facilitate a clear understanding of the features and benefits of the disclosure.

### BRIEF DESCRIPTION OF THE DRAWINGS

To elucidate the technical aspects of the embodiment of the present disclosure with greater clarity, a brief introduction to the accompanying drawings of the embodiment is provided below. It should be noted that these drawings are illustrative of certain embodiments and do not encompass all possible embodiments of the disclosure.

FIG. 1 is a perspective view of a bearing testing device proposed by the present disclosure;

FIG. 2 is a cross-sectional view taken along the central plane of the bearing testing device proposed by the present disclosure;

FIG. 3 is an end view of the bearing testing device proposed by the present disclosure, as viewed in the extending direction of the main shaft;

FIG. 4 is a simplified view of a bearing testing device proposed by the present disclosure;

FIG. 5 is a schematic diagram for adjusting the misalignment of bearings.

### REFERENCE NUMERALS

10 Main shaft
11 First bearing to be tested
111 Outer ring of the first bearing to be tested
112 Inner ring of the first bearing to be tested
12 Second bearing to be tested
121 Outer ring of the second bearing to be tested
122 Inner ring of the second bearing to be tested
X1 First axis
X2 Second axis
20 First adjusting plate
21 First oil cylinder
22 Second oil cylinder
23 Third oil cylinder
30 Second adjusting plate
31 Force sensor
41 First distance sensor
42 Second distance sensor
43 Third distance sensor
13 First support bearing
14 Second support bearing
50 The first supporting structure
51 Connecting piece
52 Rotating shaft
53 Bearing
54 Supporting column
60 The second supporting structure
70 Spring
80 Base

### DETAILED DESCRIPTION

To clarify the objectives, technical features, and benefits of the technical solution of the present disclosure, a clear and comprehensive description of the technical solution, along with the accompanying drawings of specific embodiments, is provided below. The same reference numerals in the drawings denote the same parts. It should be understood that the embodiments described herein are illustrative and not exhaustive of all possible embodiments encompassed by the present disclosure. Based on these described embodiments, any other embodiments that would be apparent to those of ordinary skill in the art without inventive labor are considered within the scope of protection of this disclosure.

Embodiments within the scope of this disclosure may differ from those depicted in the drawings by having fewer components, additional components not shown, different components, components arranged differently, or components connected differently. Moreover, two or more components shown in the drawings may be combined into a single component, or a single component may be split into multiple separate components.

Unless otherwise defined, technical and scientific terms used herein carry their ordinary meanings as understood by those skilled in the relevant field. The terms “first,” “second,” and similar descriptors used in the specification and claims do not denote any order, quantity, or significance, but are used solely to differentiate between different components. Similarly, words like “a” or “an” do not impose a quantitative limitation. Terms such as “including” or “comprising” indicate that the elements or objects listed, along with their equivalents, are covered, without precluding the presence of other elements or objects. The terms “connected” or “coupled” are not limited to direct physical or mechanical connections but may also encompass indirect electrical connections. The terms “up,” “down,” “left,” and “right” are used to describe relative positions, and these may change as the absolute position of the object being described changes.

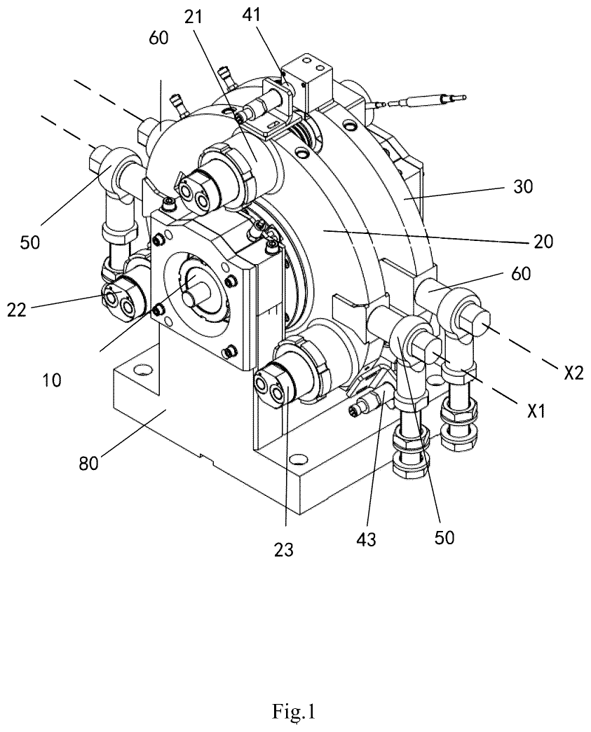

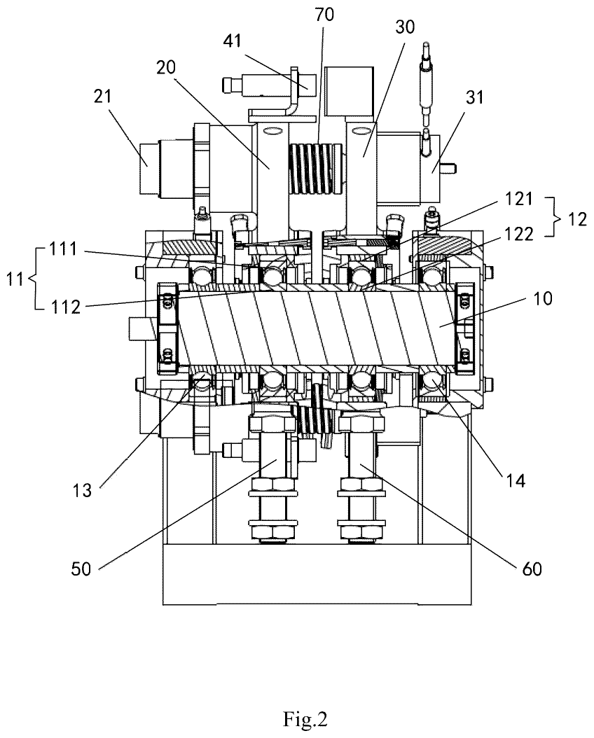

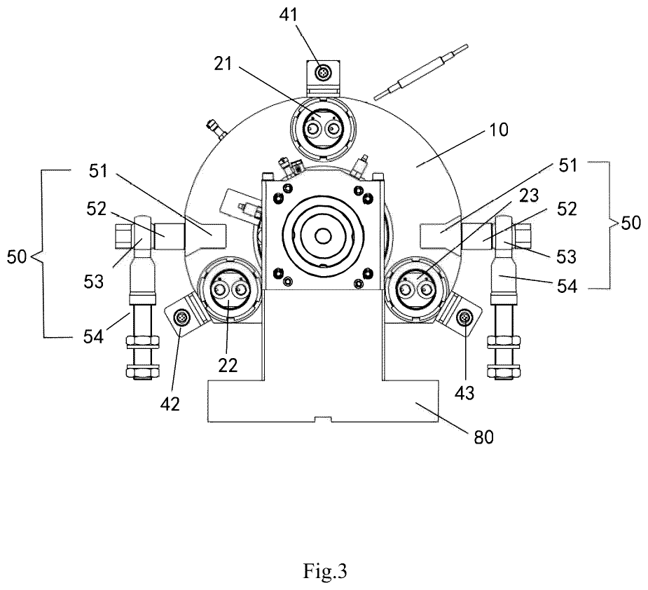

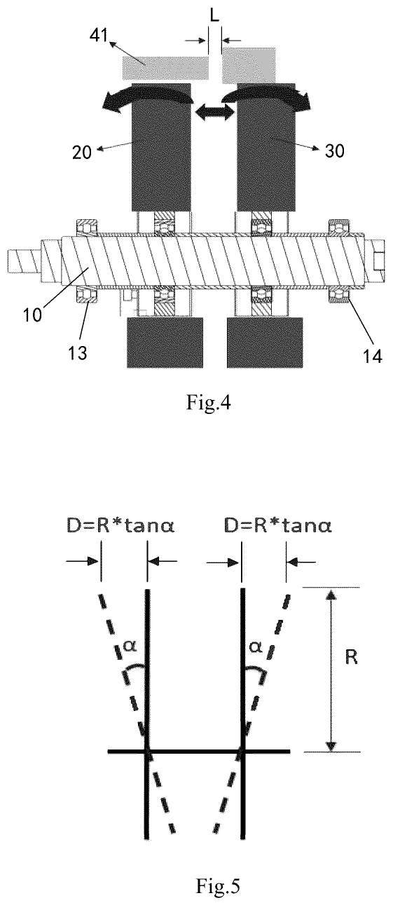

First, the bearing testing device proposed in this disclosure will be introduced with reference to FIGS. 1-4. Among them, FIG. 1 shows a perspective view of the bearing testing device proposed by the present disclosure, FIG. 2 shows a cross-sectional view of the bearing testing device proposed by the present disclosure taken along the central plane, FIG. 3 shows an end view of the bearing testing device proposed by the present disclosure viewed along the extension direction of the main shaft 10, and FIG. 4 shows a simplified view of the bearing testing device proposed by the present disclosure.

The bearing testing device disclosed by the disclosure is particularly suitable for testing the performance of bearings in a misaligned state.

Generally speaking, the bearing testing device includes a main shaft 10, a first adjusting plate 20, a second adjusting plate 30, an actuating assembly, a distance sensor assembly, and a base 80 which mainly works as a supporting structure.

The main shaft 10 of the bearing testing device is rotatably supported on the base 80. Two bearings to be measured, here called the first bearing to be tested 11 and the second bearing to be tested 12, are installed on the main shaft 10 with a certain distance between them. In the preferred embodiment shown in the attached drawings, both the first bearing to be tested 11 and the second bearing to be tested 12 are deep groove ball bearings including an outer ring, an inner ring and spherical rolling bodies located between the outer ring and the inner ring. However, the types of the bearings to be tested in this disclosure are not limited to this, but may be cylindrical roller bearings, tapered roller bearings, needle roller bearings or sliding bearings.

The inner ring 112 of the first bearing to be tested and the inner ring 122 of the second bearing to be tested are fixed relative to the main shaft 10, so that both the inner ring 112 of the first bearing to be tested and the inner ring 122 of the second bearing to be tested rotate as the main shaft 10 rotates during the test. The outer ring 111 of the first bearing to be tested and the outer ring 121 of the second bearing to be tested are directly or indirectly fixed to the first adjusting plate 20 and the second adjusting plate 30, respectively, so that the arrangement angles of the first bearing to be tested and the second bearing to be tested can be adjusted by adjusting the angles of the first adjusting plate 20 and the second adjusting plate 30, thereby simulating various misalignment scenes.

The specific structures of the first adjusting plate 20 and the second adjusting plate 30 are not restricted; they can be single plate structures, such as solid plates or partially solid plates, or they may be combined structures comprising multiple plates. The main shaft 10 extends through the first adjusting plate 20 and the second adjusting plate 30. In the specific embodiment of FIGS. 1-3, the contour of the first adjusting plate 20 and the second adjusting plate 30 are circular, and the center of the circular contour is located on the axis of rotation of the main shaft 10. Alternatively, the first adjusting plate 20 and the second adjusting plate 20 may have other profiles, such as a complete circular profile, a polygonal profile, and the like.

FIG. 1 shows a first axis X1 and a second axis X2, both of which are perpendicular to the extending direction of the main shaft 10. The first adjusting plate 20 is configured to be able to rotate around the first axis X1 by a certain angle, and the second adjusting plate 30 is configured to be able to rotate around the second axis X2 by a certain angle. FIG. 4 schematically shows that the first adjusting plate 20 rotates counterclockwise around its rotation axis as indicated by the arrow, and the second adjusting plate 30 rotates clockwise around its rotation axis as indicated by the arrow. In FIG. 5, a solid line shows that the first adjusting plate 20 and the second adjusting plate 30 are perpendicular to the main shaft 10. At this time, the bearings are in a centering state, and the rotation axis of each bearing coincides with the rotation axis of the main shaft 10. The dotted line shows that the first adjusting plate 20 rotates by an angle a in the counterclockwise direction and the second adjusting plate 30 rotates by an angle a in the clockwise direction. At this time, the rotation axis of each of the two bearings to be tested is different from the rotation axis of the main shaft 10 by a.

The inner ring 112 of the first bearing to be tested and the inner ring 122 of the second bearing to be tested are preferably directly fixed to the main shaft 10. The outer ring 111 of the first bearing to be tested and the outer ring 121 of the second bearing to be tested may be directly or indirectly fixed to the first adjusting plate 20 and the second adjusting plate 30. In the preferred embodiment shown in the attached drawings, an intermediate piece exists between the outer ring of the bearing to be tested and the corresponding adjusting plate to facilitate the connection between the outer ring of the bearing to be tested and the corresponding adjusting plate.

The actuating assembly is configured to adjust the angle of the first adjusting plate 20 with respect to the first axis X1 and the angle of the second adjusting plate 30 with respect to the second axis X2. Therefore, through the operation of the actuating assembly, the first adjusting plate 20 and the second adjusting plate 30 can be adjusted to different angles in an automatic manner to simulate different misalignment scenes. In addition, the misalignment angle can be changed during the test by means of the actuating assembly.

The actuating assembly is preferably a plurality of cylinders. The oil cylinder can also be called a hydraulic cylinder or a hydraulic cylinder, and its specific structure or form is not limited as long as it can controllably apply an adjustable thrust to the first adjusting plate 20 and the second adjusting plate 30.

Preferably, the actuating assembly includes a first oil cylinder 21, a second oil cylinder 22 and a third oil cylinder 23 for applying forces to the first adjusting plate 20 in the axial direction of the main shaft 10. Wherein, the first oil cylinder, the second oil cylinder and the third oil cylinder are installed on the first adjusting plate, and their respective push rods abut against the second adjusting plate. Referring to FIGS. 1 and 2, the main body of each oil cylinder can be installed on the left side of the first adjusting plate, that is, the side far away from the second adjusting plate, and at the same time, a through hole is arranged on the first adjusting plate, so that the push rod of each oil cylinder passes through the through hole and abuts against the second adjusting plate. When the oil cylinder exerts thrust through the push rod, it simultaneously exerts force on the first adjusting plate and the second adjusting plate. By assigning three oil cylinders to each adjusting plate, the position of each adjusting plate can be fully adjusted with the least number of oil cylinders.

Alternatively, the first oil cylinder, the second oil cylinder and the third oil cylinder can be installed on the second adjusting plate, and their respective push rods abut against the first adjusting plate.

In the drawing, the push rod of the oil cylinder is blocked by the spring 70, and thus is not shown.

The first oil cylinder 21, the second oil cylinder 22 and the third oil cylinder 23 may be uniformly arranged around the rotation axis of the main shaft 10. In the preferred embodiment shown in the attached drawings, the first oil cylinder 21, the second oil cylinder 22 and the third oil cylinder 23 are uniformly arranged along the rotation axis of the main shaft 10, and the second oil cylinder 22 and the third oil cylinder 23 are arranged at the same height. In this way, the lower two oil cylinders are symmetrical. When it is necessary to adjust the angles of the first adjusting plate 20 and the second adjusting plate 30, the lower two oil cylinders only need to apply the same force. This solution can simplify the control of the oil cylinder.

The bearing testing device of the present disclosure further includes a plurality of distance sensors for measuring distances between the first adjusting plate 20 and the second adjusting plate 30 at a plurality of different positions. Preferably, the plurality of distance sensors include a first distance sensor 41, a second distance sensor 42 and a third distance sensor 43 which are uniformly arranged around the rotation axis of the main shaft 10. Preferably, the first distance sensor 41, the second distance sensor 42 and the third distance sensor 43 are arranged at the same radial position.

The first distance sensor 41, the second distance sensor 42, and the third distance sensor 43 may be installed on, near, or at radially outward positions of the edges of the first and/or second adjusting plates 20 and 30.

By arranging a distance sensor assembly with a plurality of distance sensors, especially by arranging three evenly distributed distance sensors, the position states of the first adjusting plate 20 and the second adjusting plate 30 can be accurately known, so as to judge whether the current angles of the two adjusting plates meet the misalignment requirements of the test experiment.

Each distance sensor may have two parts, which are respectively installed on the first adjusting plate 20 and the second adjusting plate 30. Alternatively, each distance sensor may be an integrated device, which is installed on the first adjusting plate 20 or the second adjusting plate 30, and directly measures its distance from another adjusting plate or an additional component installed on another adjusting plate. The reading of the distance sensor can directly reflect the distance between the specific positions of the two adjusting plates. Alternatively, the distance between two adjusting plates at a specific position can be obtained by calculating the readings of the distance sensor.

Preferably, the oil cylinders are arranged correspondingly to the distance sensors, so that the circumferential angular positions of the three oil cylinders are the same as those of the three distance sensors. As shown in the drawings, the first oil cylinder 21 and the first distance sensor 41 are arranged at the same circumferential angle, the second oil cylinder 22 and the second distance sensor 42 are arranged at the same circumferential angle, and the third oil cylinder 23 and the third distance sensor 43 are arranged at the same circumferential angle. With this arrangement, it is possible to know from the readings of the three distance sensors which cylinder should be adjusted.

FIG. 5 shows a schematic diagram of the device of the present disclosure for adjusting the misalignment degree of bearings. Where D represents the distance between the two adjusting plates measured at the installation position of the distance sensor, R represents the distance of the distance sensor relative to the center of the main shaft 10, and α represents the misalignment angle, and D=R*tanα. Therefore, the angle of the first adjusting plate 20 with respect to the first axis X1 and the angle of the second adjusting plate 30 with respect to the second axis X2 can be adjusted based on the readings of a plurality of distance sensors.

When the preset misalignment angle is α, the distance measured by the distance sensor with a distance R from the rotation axis of the main shaft 10 should be R*tanα. If the distance D measured by the distance sensor is greater than R*tanα, the axial force exerted by the cylinder at this position should be reduced, and the axial force of other cylinders should be increased in order to keep the total axial force exerted by all cylinders unchanged. Similarly, if the distance D measured by the distance sensor is less than R*tanα, the axial force of the cylinder at this position should be increased, and the axial force of other cylinders should be reduced while keeping the total axial force exerted by all cylinders unchanged.

The bearing testing device disclosed by the present disclosure can accurately measure and accurately control the misalignment of the bearing to be tested. Moreover, the device allows closed-loop control of the adjustment process by adopting PID.

The bearing testing device of the present disclosure further includes a supporting structure for supporting the adjusting plate. The first adjusting plate 20 is supported by the first supporting structure 50 and can rotate around the first axis X1 relative to the first supporting structure 50, and the second adjusting plate 30 is supported by the second supporting structure 60 and can rotate around the second axis X2 relative to the second supporting structure 60.

In addition to their supporting roles, the first supporting structure 50 and the second supporting structure 60 are also configured to be able to apply radial force to the first adjusting plate 20 and the second adjusting plate 30, respectively, so as to keep the bearing testing device vertical. In the embodiment of the drawings, the direction of the applied force is downward. Before or during the test, the heights of the first support structure 50 and the second support structure 60 can be adjusted by adjusting parts not shown in the figure, so as to adjust the magnitude of the applied radial force.

The first supporting structure 50 may include two identical parts, located at two sides of the first adjusting plate 20 at the three o'clock and nine o'clock positions, to support the first adjusting plate 20 so as to allow the first adjusting plate 20 to rotate. Similarly, the second supporting structure 60 may include two identical parts, located at two sides of the second adjusting plate 30, at the three o'clock position and the nine o'clock position, to support the second adjusting plate 30 so as to allow the second adjusting plate 30 to rotate.

In the illustrated embodiment, the first supporting structure 50 includes a connecting piece 51 fixed to the first adjusting plate 20, a rotating shaft 52 fixedly connected with the connecting piece 51, a bearing 53 supporting the rotating shaft 52, and a supporting column 54 supporting the bearing 53. The connecting piece 51 may have engagement arms respectively fixed to both surfaces of the first adjusting plate 20 to clamp and fix the first adjusting plate 20. The rotating shaft 52 extends from the connecting member 51 in the radial direction. The bearing 53 is preferably a joint bearing, and the rotating shaft 52 can rotate in the bearing 53.

The second supporting structure 60 may have the same structure as the first supporting structure 50.

The bearing testing device of the present disclosure further includes one or more springs 70 located between the first adjusting plate 20 and the second adjusting plate 30, so as to play a buffering role when the distance between the adjusting plates is adjusted by the oil cylinder, which is beneficial to stabilizing the adjustment process.

Preferably, the bearing testing device includes a plurality of springs 70 evenly distributed around the rotation axis of the main shaft 10. More preferably, the bearing testing device includes three springs 70 evenly distributed around the rotation axis of the main shaft 10. It is particularly preferable that the positions of the three springs 70 of the bearing testing device are consistent with the positions of the oil cylinders on each adjusting plate. Preferably, three springs 70 surround the push rods of three cylinders, respectively.

The bearing testing device of the present disclosure further includes a first support bearing 13 and a second support bearing 14 mounted to the main shaft 10, and the first support bearing 13 and the second support bearing 14 are located at both sides of the mounting positions of the first bearing 11 and the second bearing 12 to be tested. The first support bearing 13 and the second support bearing 14 are configured to support the rotation of the main shaft 10. In the preferred embodiment of the drawings, the first support bearing 13 and the second support bearing 14 are deep groove ball bearings. But the type is not limited to this, alternatives include cylindrical roller bearings, tapered roller bearings, needle roller bearings, sliding bearings, etc.

The bearing testing device of the present disclosure may further include one or more force sensors, such as the force sensor 31 shown in FIG. 2, to measure the magnitude of the force at the corresponding oil cylinder.

Next, a method of testing the performance of the first bearing 11 and the second bearing 12 under misalignment by using the bearing testing device of the present disclosure will be described.

Before the test, the first assembly may include installing the first bearing to be tested 11 and the second bearing to be tested 12 on the main shaft 10 of the bearing testing device, and fixing the outer ring 111 of the first bearing to be tested and the outer ring 121 of the second bearing to the first adjusting plate 20 and the second adjusting plate 30, respectively. The assembling step may further include assembling the first support bearing 13 and the second support bearing 14, assembling the oil cylinder, assembling the distance sensors, and the like.

Secondly, by the actuating assembly, the angle of the first adjusting plate 20 relative to the first axis X1 and the angle of the second adjusting plate 30 relative to the second axis X2 are adjusted until the predetermined misaligned state of the first bearing to be tested 11 and the second bearing to be tested 12 is reached, that is, the predetermined misalignment angle a is realized. Based on the principle described above in connection with FIG. 5, the adjustment is made based on the readings of the plurality of distance sensors. Taking the preferred embodiment shown in the drawings as an example, assuming that the total axial force provided by the three cylinders is Fa, the force provided by each cylinder can be made Fa/3 at first. If the required angle for misalignment is α, and the distance from the distance sensor i to the rotation axis of the main shaft 10 is Ri, the distance measured by the distance sensor i should be Ri*tanα, which is called the target distance value. The actual distance value measured by the distance sensor i will be compared with the target distance value. If the measured value of the first distance sensor 41 is less than its target distance value, the axial output force of the first oil cylinder 21 can be increased and the axial output forces of the second oil cylinder 22 and the third oil cylinder 23 can be decreased. Multiple adjustments can be made through PID control until the measured value of the first distance sensor 41 is equal to the target distance value. At this time, if the measured values of the second distance sensor 42 and the third distance sensor 43 are also equal to their target distance values, then it means that the desired misaligned state is achieved and the test can be started. If the measured values of the second distance sensor 42 and the third distance sensor 43 are not equal to their target distance values, the axial force of the second oil cylinder 22 and the third oil cylinder 23 is adjusted until the measured values of the second distance sensor 42 and the third distance sensor 43 are also equal to their target distance values. In this way, the misaligned state of the bearing can be adjusted efficiently and accurately.

After the predetermined misaligned state is achieved, the performance test of the bearing to be tested can be conducted. It should be noted that the above-mentioned adjustment process can also be carried out once or even many times in the test process to test the bearing performance under more misalignment conditions.

The exemplary implementation of the solution outlined in this disclosure has been thoroughly detailed above, referencing the preferred embodiments. Nonetheless, it is understood by those well-versed in the field that a multitude of variations and adaptations can be applied to these specific embodiments without deviating from the underlying principle of this disclosure. Additionally, the various technical features and structures introduced in this document can be amalgamated in diverse combinations without surpassing the boundaries of the protection scope delineated by the appended claims.

What is claimed is:

1. A bearing testing device for testing the performance of a first bearing and/or a second bearing in a misaligned state, the bearing testing device comprising:
a main shaft configured to install the first bearing and the second bearing;
a first adjusting plate configured to be able to rotate around a first axis perpendicular to the main shaft for a certain angle, the first adjusting plate configured to directly or indirectly hold the outer ring of the first bearing;
a second adjusting plate configured to be able to rotate around a second axis perpendicular to the main shaft for a certain angle, the second adjusting plate configured to directly or indirectly hold the outer ring of the second bearing; and
an actuating assembly configured to adjust the angle of the first adjusting plate relative to the first axis and the angle of the second adjusting plate relative to the second axis.

2. The bearing testing device according to claim 1, further comprising a plurality of distance sensors for measuring distances between the first adjusting plate and the second adjusting plate at a plurality of different positions.

3. The bearing testing device according to claim 2, wherein the plurality of distance sensors comprise a first distance sensor, a second distance sensor, and a third distance sensor, the first, second, and third distance sensors being uniformly arranged around the axis of the main shaft.

4. The bearing testing device according to claim 3, wherein the actuating assembly comprises a first oil cylinder, a second oil cylinder, and a third oil cylinder, the first, second, and third oil cylinders configured to apply forces along an axial direction of the main shaft to the first adjusting plate;
wherein the first, second, and third oil cylinders are each installed on the first adjusting plate, the first, second, and third oil cylinders each including a push rod abutting against the second adjusting plate;
wherein the first oil cylinder and the first distance sensor are arranged at a same circumferential angle, the second oil cylinder and the second distance sensor are arranged at a same circumferential angle, and the third oil cylinder and the third distance sensor are arranged at a same circumferential angle.

5. The bearing testing device according to claim 4, wherein the second cylinder and the third cylinder are arranged at a same height.

6. The bearing testing device according to claim 1, further comprising a first supporting structure and a second supporting structure, the first adjusting plate is supported by the first supporting structure and is rotatable around a first axis relative to the first supporting structure, the second adjusting plate is supported by the second supporting structure and is rotatable around a second axis relative to the second supporting structure, the first supporting structure is configured to apply a force in a radial direction to the first adjusting plate, and the second supporting structure is configured to apply a force in a radial direction to the second adjusting plate.

7. The bearing testing device according to claim 1, further comprising a first support bearing and a second support bearing installed on the main shaft, the first support bearing and the second support bearing being located at both sides of the installation positions of the first bearing and the second bearing.

8. The bearing testing device according to claim 4, further comprising three springs located between the first adjusting plate and the second adjusting plate, each spring being consistent with the position of the corresponding oil cylinder.

9. A method for testing the performance of a first bearing and a second bearing in a misaligned state by a bearing testing device, the method comprising:
installing the first bearing and the second bearing on a main shaft of the bearing testing device;
fixing an outer ring of the first bearing to a first adjusting plate of the bearing testing device;
fixing an outer ring of the second bearing to a second adjusting plate of the bearing testing device;
adjusting an angle of the first adjusting plate relative to a first axis and an angle of the second adjusting plate relative to a second axis by means of the actuating assembly until a predetermined misaligned state of the first bearing and the second bearing is reached.

10. The method of claim 9, further comprising:
measuring distances between the first adjusting plate and the second adjusting plate at a plurality of different positions; and
adjusting the angle of the first adjusting plate relative to the first axis and the angle of the second adjusting plate relative to the second axis based on the measured distances.

11. The method of claim 10, wherein said measuring distances is with a plurality of distance sensors of the bearing testing device.
